(19) United States
(12) Patent Application Publication
(10) Pub. No.: US 2024/0284925 A1
(43) Pub. Date: Aug. 29, 2024

(54) EDIBLE NANOCOATINGS AND METHODS OF USING THEREOF

(71) Applicant: The Texas A&M University System, College Station, TX (US)

(72) Inventors: Luis Cisneros-Zevallos, College Station, TX (US); Mustafa Akbulut, College Station, TX (US)

(21) Appl. No.: 18/571,426

(22) PCT Filed: Jun. 16, 2022
(86) PCT No.: PCT/US2022/033825

§ 371 Date: Dec. 18, 2023

Related U.S. Application Data
(60) Provisional application No. 63/211,198, filed on Jun. 16, 2021.

(51) Int. Cl. A23B 7/16; A23B 7/154; A23L 3/3508

(52) U.S. Cl. CPC A23B 7/16; A23B 7/154; A23L 3/3508

(57) ABSTRACT

Described herein are coating compositions and methods of treating fruits and vegetables to resemble the visual appearance of a natural wax bloom on the surface of the fruit or vegetable. The coating composition including a coating agent. The method including applying a coating composition to a surface of the fruit or vegetable, and drying the coating composition on the surface of the fruit or vegetable.

### CROSS REFERENCE TO RELATED APPLICATIONS

This application claims benefit of priority of U.S. Provisional Application No. 63/211,198, filed Jun. 16, 2021, which is hereby incorporated by reference in its entirety.

### BACKGROUND

Epicuticular wax is a coating of wax covering the outer surface of the plant cuticle in land plants. It may form a whitish film or bloom on leaves, fruits and other plant organs, known as “wax bloom”. Epicuticular wax decreases surface wetting and moisture loss.

Quality of various fruits including blueberry fruit is associated with the appearance of wax bloom, taste, and firmness of the fruit. Postharvest quality and freshness of a blueberry fruit is in part associated with the presence of a surface wax bloom established during fruit growth and development. It is the outward indicator of freshness and translates into higher prices for blueberries.

Therefore, there is a need to resemble the visual appearance of a natural wax bloom on the fruit or vegetable surface. The compositions and methods disclosed herein address these and other needs.

### SUMMARY

Provided herein are compositions for coating fruits and vegetables as well as methods of using thereof to form coatings on fruits and vegetables.

For example, described herein are methods of treating fruits and vegetables. These methods can comprise (a) applying a coating composition to a fruit or vegetable surface; and (b) drying the coating composition on the fruit or vegetable surface. The coating composition can comprise a coating agent comprising a fatty acid, an alkyl ester, a fatty alcohol, a triterpenoid, or any combination thereof. In some embodiments, the coating composition can be present in an effective amount to coat the fruit or vegetable surface to resemble the visual appearance of a natural wax bloom on the fruit or vegetable surface. In some embodiments, the coating composition can be present in an effective amount to decrease water loss from the fruit or vegetable via evaporation, thereby reducing mass loss of the fruit or vegetable over time. In some embodiments, the coating composition can be present in an effective amount to suppress or slow microbial growth, fungal growth, and/or spoilage.

The coating composition can be applied by any suitable method, such as spray coating. In some embodiments, step (b) can comprise drying the coating composition using compressed air or nitrogen, air drying with a fan at high speed, or any combination thereof. In some embodiments, step (b) comprises drying the coating composition over a period time (e.g., over a period of time of from 10 seconds to 5 minutes, from 10 seconds to 1 minute, from 10 seconds to 2 minutes, from 10 seconds to 3 minutes, from 10 seconds to 4 minutes, from 1 minute to 2 minutes, from 1 minute to 3 minutes, from 1 minute to 4 minutes, from 1 minute to 5 minutes, from 2 minutes to 3 minutes, from 2 minutes to 4 minutes, from 3 minutes to 5 minutes, or from 4 minutes to 5 minutes).

In some embodiments, these methods can further comprise measuring the surface coverage of the coating on the fruit or vegetable surface (e.g., to assess and/or ensure a desired surface coverage on the fruit or vegetable). Surface coverage can be evaluated using a variety of suitable methods, including scanning electron microcopy (SEM), cameras, image analysis and optical profilometry.

In some embodiments, the method further comprises preparing the coating composition by dissolving the coating agent in a solvent. The solvent can comprise an alcohol (e.g., ethanol, methanol, isopropanol, or any combination thereof), ethyl acetate, an ether, water, or any combination thereof (e.g., a water/alcohol mixture). In some embodiments, the solvent comprises alcohol. In some embodiments, the coating agent(s) and the solvent are present in the coating composition in a ratio ranging from 0.1:10 to 3:10, such as from 0.5:10 to 2.5:10, from 1:10 to 2:10, from 1:10 to 2.5:10, from 0.5:10 to 2:10, from 0.5:10 to 1.5:10, from 1:10 to 3:10, or from 1:10 to 2.5:10, from 1.5:10 to 3:10, or from 2:10 to 3:10, such as about 0.1:10, about 0.5:10, about 1:10, about 1.5:10, about 2:10, about 2.5:10, or about 3:10.

In some embodiments, the coating agent comprises a fatty acid. The fatty acid can be a short or long chain saturated or monounsaturated fatty acid. In some embodiments, the fatty acid is a long chain saturated fatty acid, such as caprylic acid, capric acid, lauric acid, myristic acid, palmitic acid, stearic acid, or any combination thereof. In some embodiments, the fatty acid comprises stearic acid.

In some embodiments, the coating agent comprises a triterpenoid. The triterpenoid is a pentacyclic triterpenoid such as oleanolic acid, ursolic acid, betulinic acid, moronic acid, erythrodiol, celastrol, or any combination thereof. In some embodiments, the triterpenoid is oleanolic acid.

In some embodiments, the coating agent comprises a long chain saturated fatty acid and a triterpenoid. In some embodiments, the coating composition comprises a coating agent comprising stearic acid and oleanolic acid. In some embodiments, the long chain saturated fatty acid and the triterpenoid can be present in a ratio of from 0.01:5 to 10:0.01, such as 1:6 to 6:1, from 1:9 to 9:1, from 1:1 to 6:1, from 1:1 to 9:1, from 1:1 to 10:0.1, from 0.1:5 to 10:0.1, from 1:9 to 6:1, from 1:6 to 1:1, from 1:3 to 1:1, from 1:9 to 1:1, or from 1:6 to 9:1. In some embodiments, the long chain saturated fatty acid and the triterpenoid can be present in a ratio of from 1:1 to 6:1, from 2:1 to 6:1, from 3.1 to 6.1, from 4:1 to 6:1, from 5:1 to 6:1, such as about 2:1, about 3:1, about 4:1, about 5:1.

In some embodiments, the long chain saturated fatty acid can be present in the coating composition in a concentration of less than 10 g/L of the coating composition, (e.g., less than 9 g/L, less than 8 g/L, less than 7 g/L, less than 6 g/L, less than 5 g/L, less than 4 g/L, less than 3 g/L, less than 2 g/L, less than 1 g/L, or less than 0.5 g/L of the coating composition).

In some embodiments, the long chain saturated fatty acid can be present in the coating composition in a concentration ranging of from at least 0.01 g/L of the coating composition, (e.g., at least 0.5 g/L, at least 1 g/L, at least 2 g/L, at least 3 g/L, at least 4 g/L, at least 5 g/L, at least 6 g/L, at least 7 g/L, at least 8 g/L, or at least 9 g/L of the coating composition).

The long chain saturated fatty acid can be present in the coating composition in a concentration ranging from any of the minimum values described above to any of the maximum values described above. For example, in some embodiments, the long chain saturated fatty acid can be present in the coating composition in a concentration ranging of from 0.01 g/L to 10 g/L of the coating composition, (e.g., from 0.5 g/L to 10 g/L, from 1 g/L to 10 g/L, from 2 g/L to 10 g/L, from 3 g/L to 10 g/L, from 4 g/L to 10 g/L, from 5 g/L to 10 g/L, from 6 g/L to 10 g/L, from 7 g/L to 10 g/L, from 8 g/L to 10 g/L, from 9 g/L to 10 g/L, from 1 g/L to 5 g/L, from 1 g/L to 3 g/L, from 1 g/L to 6 g/L, from 1 g/L to 8 g/L, from 1 g/L to 9 g/L, from 0.5 g/L to 8 g/L, from 0.5 g/L to 5 g/L, from 0.5 g/L to 2 g/L, from 2 g/L to 5 g/L, or from 2 g/L to 8 g/L).

In some embodiments, the triterpenoid can be present in the coating composition in a concentration of less than 9 g/L of the coating composition, (e.g., less than 8 g/L, less than 7 g/L, less than 6 g/L, less than 5 g/L, less than 4 g/L, less than 3 g/L, less than 2 g/L, less than 1 g/L, or less than 0.5 g/L of the coating composition).

In some embodiments, the triterpenoid can be present in the coating composition in a concentration ranging of from at least 0.01 g/L of the coating composition, (e.g., at least 0.5 g/L, at least 1 g/L, at least 2 g/L, at least 3 g/L, at least 4 g/L, at least 5 g/L, at least 6 g/L, at least 7 g/L, at least 8 g/L of the coating composition).

The triterpenoid can be present in the coating composition in a concentration ranging from any of the minimum values described above to any of the maximum values described above. For example, in some embodiments, the triterpenoid can be present in the coating composition in a concentration ranging of from 0.01 g/L to 9 g/L of the coating composition, (e.g., from 0.5 g/L to 9 g/L, from 1 g/L to 9 g/L, from 2 g/L to 9 g/L, from 3 g/L to 9 g/L, from 4 g/L to 9 g/L, from 5 g/L to 9 g/L, from 6 g/L to 9 g/L, from 7 g/L to 9 g/L, from 8 g/L to 9 g/L, from 1 g/L to 5 g/L, from 1 g/L to 3 g/L, from 1 g/L to 6 g/L, from 1 g/L to 8 g/L, from 1 g/L to 9 g/L, from 0.5 g/L to 8.6 g/L, from 0.01 g/L to 8.6 g/L, from 0.5 g/L to 5 g/L, from 0.5 g/L to 2 g/L, from 2 g/L to 5 g/L, or from 2 g/L to 8 g/L).

In some embodiments, the coating composition is applied in a concentration of about 7.5 g/L of long chain saturated fatty acid and about 2.5 g/L of triterpenoid. In some embodiments, the fruit is a blueberry.

Described herein are also coated fruits or vegetables comprising a fruit or vegetable; and a coating disposed on a surface of the fruit or vegetable. In some embodiments, the coating comprises a coating agent comprising a fatty acid, an alkyl ester, a fatty alcohol, a triterpenoid, or any combination thereof. In some embodiments, the coating agent is present in an effective amount to coat the fruit or vegetable to resemble the visual appearance of a natural wax bloom on the fruit or vegetable surface. In some embodiments, the coated fruit or vegetable has a coating surface coverage of from 1% to 100%, such as from 1% to 10%, from 1% to 20%, from 1% to 30%, from 1% to 40%, from 1% to 50%, from 1% to 60%, from 1% to 70%, from 1% to 80%, from 1% to 90%, from 10% to 20%, from 10% to 30%, from 10% to 40%, from 10% to 50%, from 10% to 60%, from 10% to 70%, from 10% to 80%, from 10% to 90%, from 10% to 100%, from 20% to 30%, from 20% to 50%, from 20% to 70%, from 20% to 100%, from 30% to 80%, from 40% to 80%, from 50% to 70%, or from 50% to 100%, as determined by image analysis.

In some embodiments, the coated fruit or vegetable has an amount of coating agent ranging from 650 μg to 4500 μg, such as from 650 μg to 2500 μg, from 850 μg to 2500 μg, from 650 μg to 2200 μg, from 700 μg to 2200 μg, from 850 μg to 2200 μg, from 900 μg to 2200 μg, from 800 μg to 2200 μg, from 900 μg to 2150 μg, from 900 μg to 2500 μg, from 904 μg to 2143 μg, from 2200 μg to 4500 μg, from 2200 μg to 3200 μg, from 2200 μg to 3100 μg, from 3100 μg to 4500 μg, from 3100 μg to 4300 μg, or from 3000 μg to 4300 μg per coated fruit or vegetable. In some embodiments, coated fruit is a blueberry.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 is a table showing the coating results on bare blueberries (fruit with original wax bloom) and wiped blueberries (wax bloom removed or wiped with tissue paper) for different ratios of stearic acid to oleanolic acid.

FIG. 2 are images showing the results of bare blueberries (fruit with original wax bloom) and wiped blueberries (wax bloom removed or wiped with tissue paper) when coated with a blend of oleanolic acid and stearic acid in a ratio of 1:3. Coatings maintained the measured contact angles in bare fruit or restored it compared to wiped blueberries.

FIG. 3 shows SEM micrographs of bare blueberries (fruit with original wax bloom) and wiped blueberries (wax bloom removed or wiped with tissue paper) alone and when coated with a blend of oleanolic acid and stearic acid in a ratio of 1:3.

Like reference symbols in the various drawings indicate like elements.

### DETAILED DESCRIPTION

A number of embodiments of the disclosure have been described. Nevertheless, it will be understood that various modifications may be made without departing from the spirit and scope of the invention. Accordingly, other embodiments are within the scope of the following claims.

### Definitions

To facilitate understanding of the disclosure set forth herein, a number of terms are defined below. Unless defined otherwise, all technical and scientific terms used herein generally have the same meaning as commonly understood by one of ordinary skill in the art to which this disclosure belongs. Publications cited herein and the materials for which they are cited are specifically incorporated by reference.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing quantities of ingredients, reaction conditions, geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s), but may also include other elements or steps not expressly recited. Furthermore, as used herein, the use of the terms “a”, “an”, and “the” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) can includes 10% and also includes 20%, and includes percentages in between 10% and 20%, unless explicitly stated otherwise herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if a composition is described herein as including a component of type A, a component of type B, a component of type C, or any combination thereof, it is understood that this phrase describes all of the various individual and collective combinations and permutations of these components. For example, in some embodiments, the composition described by this phrase could include only a component of type A. In some embodiments, the composition described by this phrase could include only a component of type B. In some embodiments, the composition described by this phrase could include only a component of type C. In some embodiments, the composition described by this phrase could include a component of type A and a component of type B. In some embodiments, the composition described by this phrase could include a component of type A and a component of type C. In some embodiments, the composition described by this phrase could include a component of type B and a component of type C. In some embodiments, the composition described by this phrase could include a component of type A, a component of type B, and a component of type C. In some embodiments, the composition described by this phrase could include two or more components of type A (e.g., A1 and A2). In some embodiments, the composition described by this phrase could include two or more components of type B (e g., B1 and B2). In some embodiments, the composition described by this phrase could include two or more components of type C (e.g., C1 and C2). In some embodiments, the composition described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the composition described by this phrase could include two or more of a first component (e.g., two or more components of type B (B1 and B2)), optionally one or more of a second component (e g., optionally one or more components of type A), and optionally one or more of a third component (e.g., optionally one or more components of type C). In some embodiments, the composition described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed.

As used herein, the terms “may,” “optionally,” and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

By the term “effective amount” of a coating agent sufficient amount of a coating agent to provide the desired effect. The amount of coating agent that is “effective” will vary depending on fruit or vegetable, the particular coating agent or agents, and the like. Thus, it is not always possible to specify an exact “effective amount”. However, an appropriate “effective” amount in any case may be determined by one of ordinary skill in the art using routine experimentation.

A “fatty acid” refers to an aliphatic chain with a carboxylic acid, the aliphatic chain can be saturated or unsaturated. A “short fatty acid chain” refers to a fatty acid with aliphatic tails of five or fewer carbons.

Reference will now be made in detail to specific aspects of the disclosed materials, compounds, compositions, articles, and methods, examples of which are illustrated in the accompanying Examples and Figures.

### Coating Compositions

Described herein are coating compositions for coating fruits and vegetables surface. The coating composition can include: a coating agent(s) comprising fatty acids, alkyl esters, fatty alcohols, triterpenoids, or any combination thereof. In some embodiments, the composition further comprises a solvent. In some embodiments, the solvent comprises an alcohol (e.g., ethanol, methanol, isopropanol, or any combination thereof), ethyl acetate, an ether, water, or any combination thereof (e.g., a water/alcohol mixture). In some embodiments, the solvent comprises an alcohol. In some embodiments, the coating agent(s) and the solvent are present in the coating composition in a ratio ranging from 0.1:10 to 3:10, such as from 0.5:10 to 2.5:10, from 1:10 to 2:10, from 1:10 to 2.5:10, from 0.5:10 to 2.10, from 0.5:10 to 1.5:10, from 1:10 to 3:10, or from 1:10 to 2.5:10, from 1.5:10 to 3:10, or from 2:10 to 3:10, such as about 0.1.10, about 0.5:10, about 1.10, about 1.5:10, about 2:10, about 2.5:10, or about 3:10.

In some embodiments, the coating agent comprises a fatty acid. The fatty acid can be a short or long chain saturated or monounsaturated fatty acid. In some embodiments, the fatty acid is a long chain saturated fatty acid, such as caprylic acid, capric acid, lauric acid, myristic acid, palmitic acid, stearic acid, or any combination thereof. In some embodiments, the fatty acid comprises stearic acid.

In some embodiments, the coating agent comprises a triterpenoid. The triterpenoid is a pentacyclic triterpenoid such as oleanolic acid, ursolic acid, betulinic acid, moronic acid, erythrodiol, celastrol, or any combination thereof. In some embodiments, the triterpenoid is oleanolic acid.

In some embodiments, the coating agent comprises a long chain saturated fatty acid and a triterpenoid. In some embodiments, the coating composition comprises a coating agent comprising stearic acid and oleanolic acid. In some embodiments, the long chain saturated fatty acid and the triterpenoid can be present in a ratio of from 0.01:5 to 10:0.01, such as 1:6 to 6:1, from 1:9 to 9:1, from 1:1 to 6:1, from 1:1 to 9:1, from 1:1 to 10:0.1, from 0.1:5 to 10:0.1, from 1:9 to 6:1, from 1:6 to 1:1, from 1:3 to 1:1, from 1:9 to 1:1, or from 1:6 to 9:1. In some embodiments, the long chain saturated fatty acid and the triterpenoid can be present in a ratio of from 1.1 to 6:1, from 2:1 to 6:1, from 3:1 to 6:1, from 4:1 to 6:1, from 5:1 to 6:1, such as about 2:1, about 3:1, about 4:1, about 5:1.

In some embodiments, the long chain saturated fatty acid can be present in the coating composition in a concentration of less than 10 g/L of the coating composition, (e.g., less than 9 g/L, less than 8 g/L, less than 7 g/L, less than 6 g/L, less than 5 g/L, less than 4 g/L, less than 3 g/L, less than 2 g/L, less than 1 g/L, or less than 0.5 g/L of the coating composition).

In some embodiments, the long chain saturated fatty acid can be present in the coating composition in a concentration ranging of from at least 0.01 g/L of the coating composition, (e.g., at least 0.5 g/L, at least 1 g/L, at least 2 g/L, at least 3 g/L, at least 4 g/L, at least 5 g/L, at least 6 g/L, at least 7 g/L, at least 8 g/L, or at least 9 g/L of the coating composition).

The long chain saturated fatty acid can be present in the coating composition in a concentration ranging from any of the minimum values described above to any of the maximum values described above. For example, in some embodiments, the long chain saturated fatty acid can be present in the coating composition in a concentration ranging of from 0.01 g/L to 10 g/L of the coating composition, (e.g., from 0.5 g/L to 10 g/L, from 1 g/L to 10 g/L, from 2 g/L to 10 g/L, from 3 g/L to 10 g/L, from 4 g/L to 10 g/L, from 5 g/L to 10 g/L, from 6 g/L to 10 g/L, from 7 g/L to 10 g/L, from 8 g/L to 10 g/L, from 9 g/L to 10 g/L, from 1 g/L to 5 g/L, from 1 g/L to 3 g/L, from 1 g/L to 6 g/L, from 1 g/L to 8 g/L, from 1 g/L to 9 g/L, from 0.5 g/L to 8 g/L, from 0.5 g/L to 5 g/L, from 0.5 g/L to 2 g/L, from 2 g/L to 5 g/L, or from 2 g/L to 8 g/L).

In some embodiments, the triterpenoid can be present in the coating composition in a concentration of less than 9 g/L of the coating composition, (e.g., less than 8 g/L, less than 7 g/L, less than 6 g/L, less than 5 g/L, less than 4 g/L, less than 3 g/L, less than 2 g/L, less than 1 g/L, or less than 0.5 g/L of the coating composition).

In some embodiments, the triterpenoid can be present in the coating composition in a concentration ranging of from at least 0.01 g/L of the coating composition, (e.g., at least 0.5 g/L, at least 1 g/L, at least 2 g/L, at least 3 g/L, at least 4 g/L, at least 5 g/L, at least 6 g/L, at least 7 g/L, at least 8 g/L of the coating composition).

The triterpenoid can be present in the coating composition in a concentration ranging from any of the minimum values described above to any of the maximum values described above. For example, in some embodiments, the triterpenoid can be present in the coating composition in a concentration ranging of from 0.01 g/L to 9 g/L of the coating composition, (e.g., from 0.5 g/L to 9 g/L, from 1 g/L to 9 g/L, from 2 g/L to 9 g/L, from 3 g/L to 9 g/L, from 4 g/L to 9 g/L, from 5 g/L to 9 g/L, from 6 g/L to 9 g/L, from 7 g/L to 9 g/L, from 8 g/L to 9 g/L, from 1 g/L to 5 g/L, from 1 g/L to 3 g/L, from 1 g/L to 6 g/L, from 1 g/L to 8 g/L, from 1 g/L to 9 g/L, from 0.5 g/L to 8.6 g/L, from 0.01 g/L to 8.6 g/L, from 0.5 g/L to 5 g/L, from 0.5 g/L to 2 g/L, from 2 g/L to 5 g/L, or from 2 g/L to 8 g/L).

In some embodiments, the coating composition is applied in a concentration of about 7.5 g/L of long chain saturated fatty acid and about 2.5 g/L of triterpenoid. In some embodiments, the fruit is a blueberry.

In some embodiments, the coating composition can be present in an effective amount to coat the fruit or vegetable surface to resemble the visual appearance of a natural wax bloom on the fruit or vegetable surface. In some embodiments, the coating composition can be present in an effective amount to decrease water loss from the fruit or vegetable via evaporation, thereby reducing mass loss of the fruit or vegetable over time. In some embodiments, the coating composition can be present in an effective amount to suppress or slow microbial growth, fungal growth, and/or spoilage.

In some embodiments, the fruit can include, for example, bananas, plantains, grapes; citrus fruits, pome fruits; stone fruits; berries; tropical fruits; miscellaneous fruits, and other fruits. Pome fruits include, for example, apple, pear, quince, and other pome fruits. Tropical fruits include, for example, fig, persimmon, kiwifruit, mango, avocado, pineapple, date, cashew apple, papaya, breadfruit, carambola, chrimoya, durian, feijoa, guava, mombin, jackfruit, longan, mammee, mangosteen, naranjillo, passion fruit, rambutan, sapote, sapodilla, star apple, and other tropical fruits. Stone fruits include, for example, apricots, olives, peaches, plums, cherries, mangoes, pecans, and amlas. Berries can include, for example, blueberries, raspberries, strawberries, blackberries, cranberries, lingonberries, huckleberries. In some embodiments, the fruit is a blueberry.

In some embodiments, the vegetable can include cabbages, artichokes, asparagus, lettuce, spinach, cassava leaves, tomatoes, cauliflower, cucurbits (including pumpkins, cucumbers and gherkins, squash, watermelon, cantaloupe, honeydew, and other mixed melons) eggplants, chilies and peppers, green onions, dry onions, garlic, leek, other alliaceous vegetables, green beans, green peas, green broad beans, string beans, carrots, okra, green corn, mushrooms, bamboo shoots, beets, chards, capers, cardoons, celery, chervil, cress, fennel, horseradish, marjoram, oyster plant, parsley, parsnips, radish, rhubarb, rutabaga, savory, scorzonera, sorrel, watercress, and other vegetables.

### Coated Fruits and Vegetables

Described herein are also coated fruits or vegetables comprising a fruit or vegetable; and a coating comprising a coating agent(s) disposed on a surface of the fruit or vegetable. The coating agent(s) can include fatty acids, alkyl esters, fatty alcohols, triterpenoids, or any combination thereof. In some embodiments, the coating agent comprises a fatty acid. The fatty acid can be a short or long chain saturated or monounsaturated fatty acid. In some embodiments, the fatty acid is a long chain saturated fatty acid, such as caprylic acid, capric acid, lauric acid, myristic acid, palmitic acid, stearic acid, or any combination thereof. In some embodiments, the fatty acid comprises stearic acid.

In some embodiments, the coating agent comprises a triterpenoid. The triterpenoid is a pentacyclic triterpenoid such as oleanolic acid, ursolic acid, betulinic acid, moronic acid, erythrodiol, celastrol, or any combination thereof. In some embodiments, the triterpenoid is oleanolic acid.

In some embodiments, the coating agent comprises a long chain saturated fatty acid and a triterpenoid. In some embodiments, the coating composition comprises a coating agent comprising stearic acid and oleanolic acid. In some embodiments, the long chain saturated fatty acid and the triterpenoid can be present in a ratio of from 0.01:5 to 10:0.01, such as 1:6 to 6:1, from 1:9 to 9:1, from 1:1 to 6:1, from 1:1 to 9:1, from 1:1 to 10:0.1, from 0.1:5 to 10:0.1, from 1:9 to 6:1, from 1:6 to 1:1, from 1:3 to 1:1, from 1:9 to 1:1, or from 1:6 to 9:1. In some embodiments, the long chain saturated fatty acid and the triterpenoid can be present in a ratio of from 1:1 to 6:1, from 2:1 to 6:1, from 3:1 to 6:1, from 4:1 to 6:1, from 5:1 to 6:1, such as about 2:1, about 3:1, about 4:1, about 5:1.

In some embodiments, the coating composition can be present in an effective amount to coat the fruit or vegetable surface to resemble the visual appearance of a natural wax bloom on the fruit or vegetable surface. In some embodiments, the coating composition can be present in an effective amount to decrease water loss from the fruit or vegetable via evaporation, thereby reducing mass loss of the fruit or vegetable over time. In some embodiments, the coating composition can be present in an effective amount to suppress or slow microbial growth, fungal growth, and/or spoilage.

In some embodiments, the fruit can include, for example, bananas, plantains, grapes; citrus fruits; pome fruits; stone fruits; berries; tropical fruits; miscellaneous fruits; and other fruits. Pome fruits include, for example, apple, pear, quince, and other pome fruits. Tropical fruits include, for example, fig, persimmon, kiwifruit, mango, avocado, pineapple, date, cashew apple, papaya, breadfruit, carambola, chrimoya, durian, feijoa, guava, mombin, jackfruit, longan, mammee, mangosteen, naranjillo, passion fruit, rambutan, sapote, sapodilla, star apple, and other tropical fruits. Stone fruits include, for example, apricots, olives, peaches, plums, cherries, mangoes, pecans, and amlas. Berries can include, for example, blueberries, raspberries, strawberries, blackberries, cranberries, lingonberries, huckleberries. In some embodiments, the fruit is a blueberry.

In some embodiments, the vegetable can include cabbages, artichokes, asparagus, lettuce, spinach, cassava leaves, tomatoes, cauliflower, cucurbits (including pumpkins, cucumbers and gherkins, squash, watermelon, cantaloupe, honeydew, and other mixed melons) eggplants, chilies and peppers, green onions, dry onions, garlic, leek, other alliaceous vegetables, green beans, green peas, green broad beans, string beans, carrots, okra, green corn, mushrooms, bamboo shoots, beets, chards, capers, cardoons, celery, chervil, cress, fennel, horseradish, marjoram, oyster plant, parsley, parsnips, radish, rhubarb, rutabaga, savory, scorzonera, sorrel, watercress, and other vegetables.

The coating applied to the fruit or vegetable surface need not completely cover the fruit or vegetable surface, although such embodiments may be possible. For example, the coating may surround at least about 10%, at least about 30%, at least about 50%, at least about 60%, at least about 70%, at least about 80%, at least about 90%, or at least about 99% of the surface area of a fruit or vegetable. In some cases, the coating substantially surrounds a fruit or vegetable surface. In other cases, the coating completely surrounds a fruit or vegetable surface. In other embodiments, a coating surrounds less than or equal to about 100%, less than or equal to about 90%, less than or equal to about 80%, less than or equal to about 70%, less than or equal to about 60%, or less than or equal to about 50% of the surface area of a fruit or vegetable Combinations of the above-referenced ranges are also possible (e.g., surrounding greater than 80% and less than 100% of the surface area of a fruit or vegetable).

In some embodiments, the coated fruit or vegetable has a coating surface coverage of from 1% to 100%, such as 1% to 10%, 1% to 20%, 1% to 30%, 1% to 40%, 1% to 50%, 1% to 60%, 1% to 70%, 1% to 80%, 1% to 90%, 10% to 20%, 10% to 30%, 10% to 40%, 10% to 50%, 10% to 60%, 10% to 70%, 10% to 80%, 10% to 90%, 10% to 100%, 20% to 30%, 20% to 50%, 20% to 70%, 20% to 100%, 30% to 80%, 40% to 80%, 50% to 70% or 50% to 100%, as determined by image analysis.

In some embodiments, the coated fruit or vegetable has an amount of coating agent ranging from 650 μg to 4500 μg, such as from 650 μg to 2500 μg, from 850 μg to 2500 μg, from 650 μg to 2200 μg, from 700 μg to 2200 μg, from 850 μg to 2200 μg, from 900 μg to 2200 μg, from 800 μg to 2200 μg, from 900 μg to 2150 μg, from 900 μg to 2500 μg, from 904 μg to 2143 μg, from 2200 μg to 4500 μg, from 2200 μg to 3200 μg, from 2200 μg to 3100 μg, from 3100 μg to 4500 μg, from 3100 μg to 4300 μg, or from 3000 μg to 4300 μg per coated fruit or vegetable.

### Methods of Use

Described herein are also methods of coating a fruit or vegetable comprising (a) applying a coating composition to a fruit or vegetable surface; and (b) drying the coating composition on the fruit or vegetable surface.

In some embodiments, the method further comprises measuring the surface coverage of the coating on the fruit or vegetable surface using a variety of suitable methods, including scanning electron microcopy (SEM), cameras, image analysis and optical profilometry.

In some embodiments, the method comprises applying the coating composition by spray coating. In some embodiments, step (b) comprises drying the coating composition using compressed air or nitrogen, air drying with a fan at high speed, or any combination thereof. In some embodiments, step (b) comprises drying the coating composition over a period of time (e.g., over a period of time of from 10 seconds to 5 minutes, from 10 seconds to 1 minute, from 10 seconds to 2 minutes, from 10 seconds to 3 minutes, from 10 seconds to 4 minutes, from 1 minute to 2 minutes, from 1 minute to 3 minutes, from 1 minute to 4 minutes, from 1 minute to 5 minutes, from 2 minutes to 3 minutes, from 2 minutes to 4 minutes, from 3 minutes to 5 minutes, or from 4 minutes to 5 minutes). In some embodiments, the method comprises measuring the surface coverage using a variety of suitable methods, including scanning electron microcopy (SEM), cameras, image analysis and optical profilometry.

In some embodiments, the method further comprises preparing the coating composition described herein by dissolving the coating agent in a solvent. In some embodiments, the solvent comprises an alcohol (e.g., ethanol, methanol, isopropanol, or any combination thereof), ethyl acetate, an ether, water, or any combination thereof (e.g., a water/alcohol mixture).

The coating composition as used in the methods described herein can be used in an effective amount to coat a fruit or vegetable to resemble the visual appearance of a natural wax bloom on the surface of the fruit or vegetable.

In some embodiments, the coating composition can be used in an effective amount to decrease water loss from the fruit or vegetable via evaporation, thereby reducing mass loss of the fruit or vegetable over time. In some embodiments, the coating composition can be used in an effective amount to suppress or slow microbial growth, fungal growth, and/or spoilage.

In some examples, coatings formed over produce by methods described herein can be less than 3 microns thick, less than 2 microns thick, less than 1.5 microns thick, between 0.1 and 3 microns thick, or between 0.05 and 2 microns thick, and can simultaneously reduce the rate of mass loss of the produce (as compared to similar uncoated produce at the same state of ripening) by at least 5%, at least 10%, at least 15%, at least 20%, at least 25%, at least 30%, at least 35%, or at least 40%

A number of embodiments of the disclosure have been described. Nevertheless, it will be understood that various modifications may be made without departing from the spirit and scope of the invention. Accordingly, other embodiments are within the scope of the following claims.

By way of non-limiting illustration, examples of certain embodiments of the present disclosure are given below.

### Examples

Postharvest quality and freshness of a blueberry fruit is in part associated to the presence of a surface wax bloom established during fruit growth and development. Described herein is a process based on surface treatments that could resemble the natural wax bloom during postharvest applications. The following are the proposed strategies:

a) Design of a surface bloom using a nanotechnology approach. Use different FDA-GRAS approved materials (e.g., short and long chain saturated and monounsaturated fatty acids, alkyl esters, fatty alcohols, triterpenoids and their combinations with varying relative concentrations) to develop a surface bloom involving the crystallization and deposition of these materials and their combinations on surface via solvent rapid-evaporation approach. For this purpose, use solvents ranging from polar to non-polar for delivering the surface materials (e.g., ethanol, ethyl acetate, etc). In addition, use different concentrations of the selected materials in the solvent (0.1:10 to 3:10, material to solvent ratios);

b) Another component is the optimization of solvent drying, which is the driving force inducing the formation of the bloom layer: for economic viability and scale-up feasibility, we adjust the drying timescales in the range of 10 to 30 seconds using compressed air or nitrogen; and
c) The morphological characterization of the developed bloom surfaces is performed using scanning electron microscopy (SEM). The comparison between natural bloom and treatment bloom is made to maximize the natural appearance of the bloom. In addition, use contact angle measurements on the designed surfaces to characterize the chemical/morphological coating coverage and pictures of surface coating bloom intensity for visual appearance of the blueberry bloom in a quantitative fashion. Tested fruit include fruits with two degrees of original wax bloom from (0% wax bloom to 100% wax bloom coverage). We have developed bloom in blueberries resembling the visual appearance of the original wax bloom. This information is used as the base line for treatments applied to upscale operations.

Examples are given by using a formulation of stearic acid and oleanolic acid blends with different ratios and concentrations. Pictures of surface coating blooms and contact angle measurements are used to characterize coatings.

Formulation of Coating Compositions that Resemble Natural Blueberry Wax Blooms

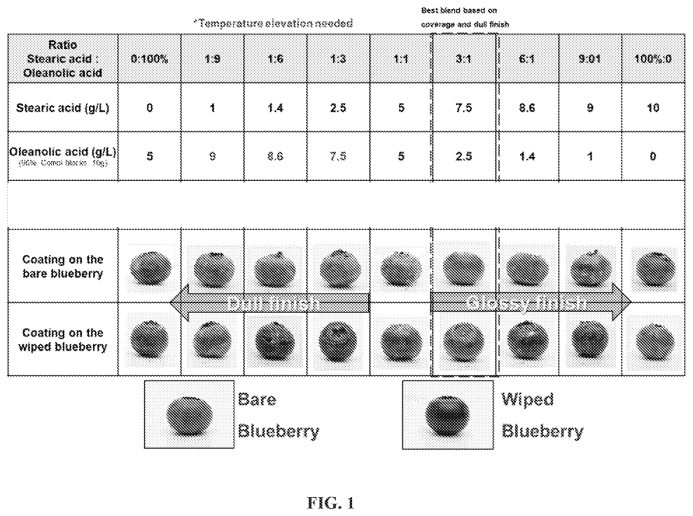

Blueberry fruit was coated with a blend of stearic acid and oleanolic acid in ratios of 0:5, 1:9, 1:6, 1:3, 1:1, 3:1, 6:1, 9:1 and 10:0. The stearic acid and oleanolic acid were dissolved in ethanol solution in concentrations ranging from 0-10 g/L and 0-8.6 g/L, respectively (FIG. 1). The coating solutions were applied by dipping or spraying to the fruit and dried immediately afterwards by using a flow of air or nitrogen. The applied coating was evaluated on bare fruit (fruit with original wax bloom) and on wiped fruit (wax bloom removed or wiped with tissue paper) and surface appearance was evaluated based on surface coverage and optical characteristics such as dull/glossy finish. Accordingly, results showed that blends with higher proportions of oleanolic acid gave a dull finish (1:9-1:1 ratio of stearic acid to oleanolic acid) while blends with higher proportions of stearic acid gave full surface coverage and glossy finish (3:1-10:0 ratio of stearic acid to oleanolic acid). The selected coating that gave full surface coverage and a matte finish resembling the original wax bloom of blueberry fruit was a blend of stearic acid to oleanolic acid in a ratio of 3:1 (FIG. 1). The amounts of solubilized compounds in ethanol are shown for each compound in the corresponding blend.

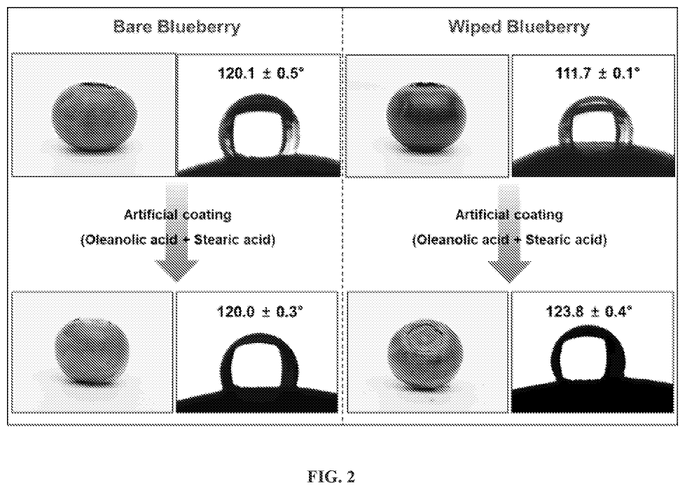

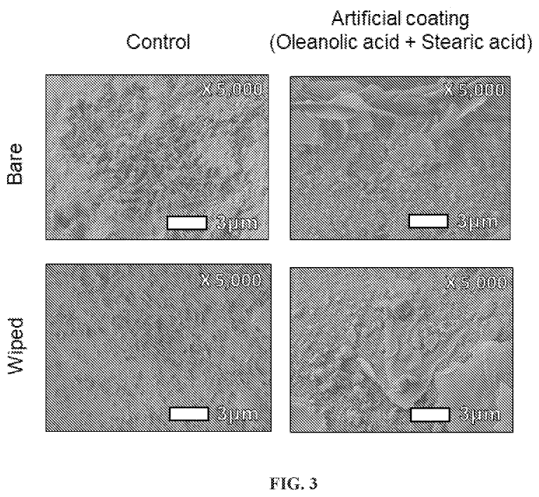

In addition, contact angle measurements, which is associated to the surface wax coverage chemistry and morphology, showed that bare fruit had higher contact angles than wiped fruit due to the wax bloom removal, while coated fruit showed restoring of the contact angle values in wiped fruit and maintenance of contact angles in bare fruit (FIG. 2). FIG. 3 shows SEM micrographs of bare blueberries (fruit with original wax bloom) and wiped blueberries (wax bloom removed or wiped with tissue paper) alone and when coated with a blend of oleanolic acid and stearic acid in a ratio of 1:3

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

1. A method of treating fruits and vegetables comprising:
(a) applying a coating composition to a fruit or vegetable surface; and
(b) drying the coating composition on the fruit or vegetable surface;
wherein the coating composition comprises a coating agent comprising a fatty acid, an alkyl ester, a fatty alcohol, a triterpenoid, or any combination thereof,
wherein the coating composition is present in an effective amount to coat the fruit or vegetable surface to resemble the visual appearance of a natural wax bloom on the fruit or vegetable surface, decrease water loss from the fruit or vegetable via evaporation, decrease microbial growth and/or spoilage of the fruit or vegetable, or any combination thereof.

2. (canceled)

3. The method of claim 1, wherein applying the coating composition comprises spray coating.

4. (canceled)

5. The method of claim 1, wherein step (b) comprises drying the coating composition over a period time of from 10 seconds to 5 minutes, such as from 10 seconds to 5 minutes, from 10 seconds to 1 minute, from 10 seconds to 2 minutes, from 10 seconds to 3 minutes, from 10 seconds to 4 minutes, from 1 minute to 2 minutes, from 1 minute to 3 minutes, from 1 minute to 4 minutes, from 1 minute to 5 minutes, from 2 minutes to 3 minutes, from 2 minutes to 4 minutes, from 3 minutes to 5 minutes, or from 4 minutes to 5 minutes.

6. The method of claim 2, wherein the method comprises measuring the surface coverage using scanning electron microcopy (SEM), cameras, image analysis and optical profilometry.

7. (canceled)

8. (canceled)

9. (canceled)

10. The method of claim 7, wherein the coating agent(s) and the solvent are present in the coating composition in a ratio ranging from 0.1:10 to 3:10, such as from 0.5:10 to 2.5:10, from 1:10 to 2:10, from 1:10 to 2.5:10, from 0.5:10 to 2:10, from 0.5:10 to 1.5:10, from 1:10 to 3:10, or from 1:10 to 2.5:10, from 1.5:10 to 3:10, or from 2:10 to 3:10, such as about 0.1:10, about 0.5:10, about 1:10, about 1.5:10, about 2:10, about 2.5:10, or about 3:10.

11. The method of claim 1, wherein the coating agent comprises a fatty acid, wherein the fatty acid is a short or long chain saturated or monounsaturated fatty acid.

12. The method of claim 11, wherein the fatty acid is a long chain saturated fatty acid, such as caprylic acid, capric acid, lauric acid, myristic acid, palmitic acid, stearic acid, or any combination thereof.

13. The method of claim 11, wherein the coating agent comprises a long chain saturated fatty acid and a triterpenoid.

14. The method of claim 13, wherein the long chain saturated fatty acid and the triterpenoid are present in a ratio ranging from 0.01:5 to 10:0.01, such as 1:6 to 6:1, from 1:9 to 9:1, from 1:1 to 6:1, from 1:1 to 9:1, from 1:1 to 10:0.1, from 0.1:5 to 10:0.1, from 1:9 to 6:1, from 1:6 to 1:1, from 1:3 to 1:1, from 1:9 to 1:1, or from 1:6 to 9:1.

15. The method of claim 14, wherein the long chain saturated fatty acid and the triterpenoid are present in a ratio ranging from 1:1 to 6:1, from 2:1 to 6:1, from 3:1 to 6:1, from 4:1 to 6:1, from 5:1 to 6:1, such as about 2:1, about 3:1, about 4:1, about 5:1.

16. The method of claim 13, wherein the long chain saturated fatty acid is stearic acid.

17. The method of claim 1, wherein the triterpenoid is a pentacyclic triterpenoid such as oleanolic acid, ursolic acid, betulinic acid, moronic acid, erythrodiol, celastrol, or any combination thereof.

18. The method claim 1, wherein the triterpenoid is oleanolic acid.

19. The method of claim 11, wherein the long chain saturated fatty acid is present in the coating composition in a concentration ranging from 0.01 to 10 g/L of the coating composition.

20. The method of claim 1, wherein the triterpenoid is present in the coating composition in a concentration ranging from 0.01 to 9 g/L of the coating composition.

21. The method of claim 1, wherein the coating composition comprises a coating agent comprising stearic acid and oleanolic acid.

22. The method of claim 13, wherein the coating composition is applied in a concentration of 7.5 g/L of long chain saturated fatty acid and 2.5 g/L of triterpenoid.

23. The method of claim 1, wherein the fruit is a blueberry.

24. A coated fruit or vegetable comprising:
a fruit or vegetable; and
a coating disposed on a surface of the fruit or vegetable,
wherein the coating comprises a coating agent comprising a fatty acid, an alkyl ester, a fatty alcohol, a triterpenoid, or any combination thereof,
wherein the coating is present in an effective amount to coat the fruit or vegetable surface to resemble the visual appearance of a natural wax bloom on the fruit or vegetable surface, decrease water loss from the fruit or vegetable via evaporation, decrease microbial growth and/or spoilage of the fruit or vegetable, or any combination thereof.

25-36. (canceled)

37. A coating composition comprising: a coating agent(s) comprising fatty acids, alkyl esters, fatty alcohols, triterpenoids, or any combination thereof,
wherein the ratio of fatty acids to triterpenoids ranges from 0.01:5 to 10:0.01,
wherein the coating composition is present in an effective amount to coat the fruit or vegetable surface to resemble the visual appearance of a natural wax bloom on the fruit or vegetable surface, decrease water loss from the fruit or vegetable via evaporation, decrease microbial growth and/or spoilage of the fruit or vegetable, or any combination thereof.

38-53. (canceled)
